(19) United States
(12) Patent Application Publication
(10) Pub. No.: US 2008/0190231 A1
(43) Pub. Date: Aug. 14, 2008

(54) Ball screw device having ball guide member

(76) Inventors: Yueh Ling Chiu, Taichung (TW); Hung Sung Pan, Taichung (TW)

Correspondence Address: CHARLES E. BAXLEY, ESQUIRE, 90 JOHN STREET, SUITE 309, NEW YORK, NY, 10038, US

(21) Appl. No.: 11/291,691

(22) Filed: Dec. 1, 2005

(51) Int. Cl. F16H 25/22

(52) U.S. Cl. 74/424.86

(57) ABSTRACT

A ball screw device includes a ball nut having a number of helical groove portions and one or more channels, a screw shaft having a number of helical groove portions for threading with the ball nut, and a number of rolling members engaged in the helical groove portions of the ball nut and the screw shaft for facilitating a movement of the ball nut relative to the screw shaft. Two or more guide members are engaged in the helical groove portions of the screw shaft, and each has a slot to form an endless ball rolling passage together with the helical groove portions and the channel of the ball nut and to slidably receive the rolling members. The guide members each includes a projection for engaging with and for anchoring to the ball nut.

### BACKGROUND OF THE INVENTION

1. Field of the Invention

The present invention relates to a ball screw device, and more particularly to a ball screw device having a ball guide member for effectively and smoothly receiving and guiding the balls or the rolling members to move relative to the ball nut and the screw shaft, and for facilitating the ball nut and the screw shaft to be rotated or moved relative to each other in great rotational speeds.

2. Description of the Prior Art

Typical ball screw devices comprise a ball nut rotatably and/or moveably engaged onto a screw shaft, and normally arranged to allow the ball nut to be rotated and/or moved relative to the screw shaft in great rotational speeds. For allowing the ball nut to be smoothly rotated and moved relative to the screw shaft, a suitable sealing and lubricating structure is required to be provided between the ball nut and the screw shaft, for lubricating the ball nut and the screw shaft.

For example, U.S. Pat. No. 6,451,744 to Chang discloses one of the typical bushing assemblies including an inbuilt lubricating member provided therein and engaged between the ball nut and the screw shaft, for lubricating the ball nut and the screw shaft. However, the inbuilt lubricating member may have a good chance to be worn out after use, such the lubrication between the ball nut and the screw shaft may be become failure.

The other conventional ball screw devices may comprise a number of balls engaged between the ball nut and the screw shaft, to allow the ball nut to be smoothly rotated and moved relative to the screw shaft. However, a precise and complicated and accurate sealing structure should be formed and provided between the ball nut and the ball screw, for suitably receiving and guiding the balls to move relative to the ball nut and the screw shaft, and to suitably retain the balls or rollers or rolling members and/or the lubricating grease or oil between the ball nut and the screw shaft.

The present invention has arisen to mitigate and/or obviate the afore-described disadvantages of the conventional ball screw devices for such as machine tools or the like.

### SUMMARY OF THE INVENTION

The primary objective of the present invention is to provide a ball screw device including a ball guide member for effectively and smoothly receiving and guiding the balls or the rolling members to move relative to the ball nut and the screw shaft, and for facilitating the ball nut and the screw shaft to be rotated or moved relative to each other in great rotational speeds.

In accordance with one aspect of the invention, there is provided a ball screw device comprising a ball nut including a bore formed therein and having an inner thread formed therein and defined by a number of helical groove portions, and including at least one channel formed therein, a screw shaft rotatably engaged into the bore of the ball nut, and including an outer thread formed thereon and defined by a number of helical groove portions for threading with the inner thread of the ball nut and for allowing the ball nut to be rotated and moved relative to the screw shaft, a number of rolling members engaged in the helical groove portions of the ball nut and the screw shaft for facilitating a movement of the ball nut relative to the screw shaft, and at least two guide members engaged in the ball nut and each including a slot formed therein for communicating the helical groove portions and the channel of the ball nut with each other, and for forming an endless ball rolling passage to slidably receive the rolling members therein, and for allowing the ball nut and the screw shaft to be smoothly rotated and moved relative to each other, particularly in great rotational speeds relative to each other.

The ball nut includes at least two depressions formed therein for receiving and positioning the guide members respectively. The ball nut includes a cavity formed therein and communicating with each of the depressions thereof, and the guide members each includes a projection extended therefrom for engaging into the depressions of the ball nut, to anchor and to position the guide members to the ball nut, and to prevent the guide members from being moved relative to the ball nut, and thus to solidly secure the guide members to the ball nut.

The projection of the guide members may be formed into various kinds of shapes, such as cross shape, rectangular or parallelepiped shape, curved shape, circular or cylindrical shape, or other geometric shapes. The ball nut includes at least two fasteners engaged therethrough and engaged with the guide members respectively, to further solidly secure the guide members to the ball nut.

The guide members each includes a curved pathway formed therein and communicating with the slot thereof and directed toward and aligned with the channel of the ball nut, to guide the rolling members to move to and from the helical groove portions of the ball nut and the screw shaft and the channel of the ball nut, or to form the endless ball rolling passage to slidably receive the rolling members.

The guide members each includes two bars to form and to define the slot thereof, and to allow the slot and the bars thereof to be aligned with or to be conformed with the inner thread or the helical groove portions of the ball nut, or to be formed or acted as a portion of the inner thread or the helical groove portions of the ball nut.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a ball screw device in accordance with the present invention;

FIG. 2 is a partial perspective view of the ball screw device, in which a portion of the ball screw device has been cut off for showing an inner structure of the ball screw device;

FIG. 3 is another partial perspective view of the ball screw device, similar to FIG. 2, in which a portion of the ball screw device has also been cut off for showing an inner structure of the ball screw device;

FIG. 4 is a plan and partial exploded view of the ball screw device;

FIG. 5 is a partial cross sectional view of the ball screw device, taken along lines 5-5 of FIG. 3;

FIG. 6 is an upper perspective view illustrating a ball guide member of the ball screw device;

FIG. 7 is a bottom perspective view of the ball guide member of the ball screw device as shown in FIG. 6;

FIG. 8 is a bottom perspective view similar to FIG. 7, illustrating the other arrangement of the ball guide member of the ball screw device;

FIG. 9 is a bottom perspective view similar to FIGS. 7 and 8, illustrating a further arrangement of the ball guide member of the ball screw device; and

FIG. 10 is a bottom perspective view similar to FIGS. 7, 8 and 9, illustrating a still further arrangement of the ball guide member of the ball screw device.

### DETAILED DESCRIPTION OF THE PREFERRED EMBODIMENT

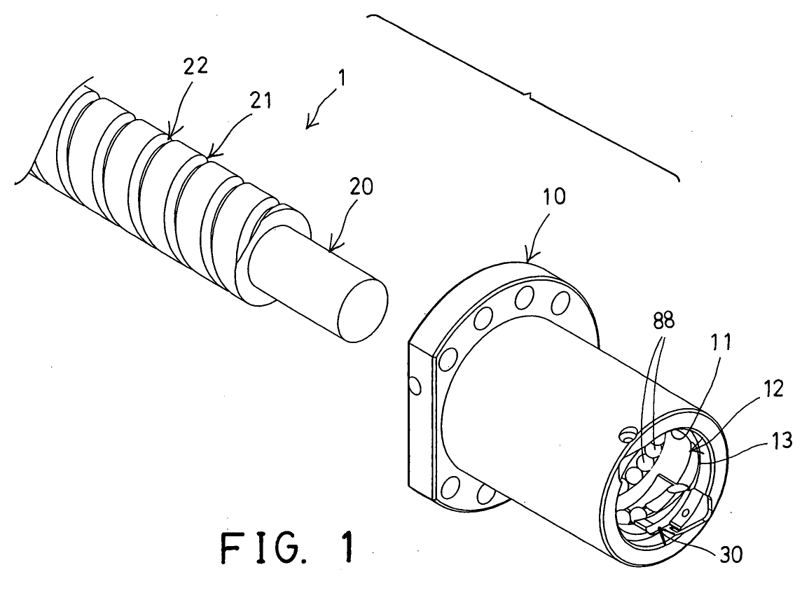

Referring to the drawings, and initially to FIGS. 1-3, a ball screw device 1 in accordance with the present invention comprises an outer ball nut 10 including a bore 11 formed therein and having a helical groove or inner thread 12 formed therein and defined by a number of peripheral and helical groove portions 13, for threading with an outer thread 21 of a screw shaft 20, and thus for allowing the ball nut 10 to be moved along the screw shaft 20, or for allowing the screw shaft 20 to be rotated and moved relative to the ball nut 10.

The screw shaft 20 also includes a number of peripheral and helical groove portions 22 formed therein for forming or defining the outer thread 21 thereof, and for rotatably and/or movably receiving balls or rollers or rolling members 88 therein which may facilitate the rotating movement of the ball nut 10 relative to the screw shaft 20 when the screw shaft 20 is forced to rotate relative to the ball nut 10 or when the ball nut 10 is forced to rotate relative to the screw shaft 20, in order to constitute the primary structure of the ball screw device 1.

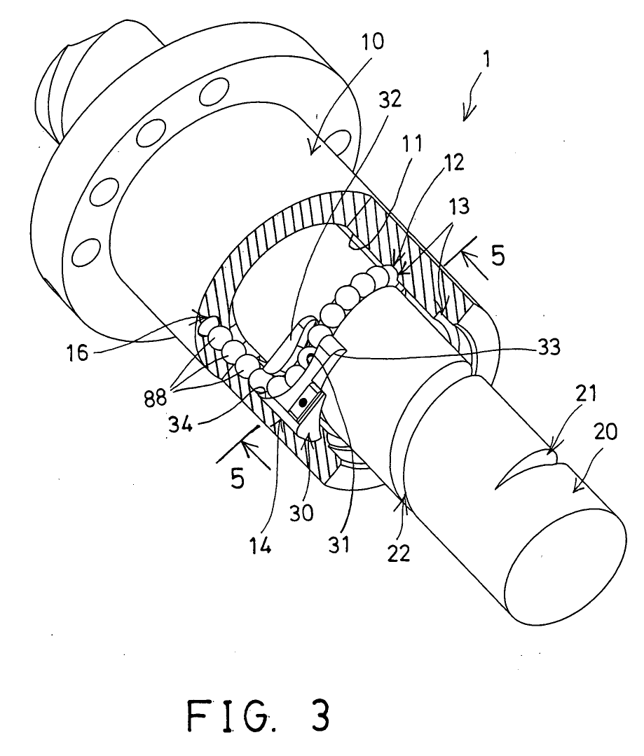

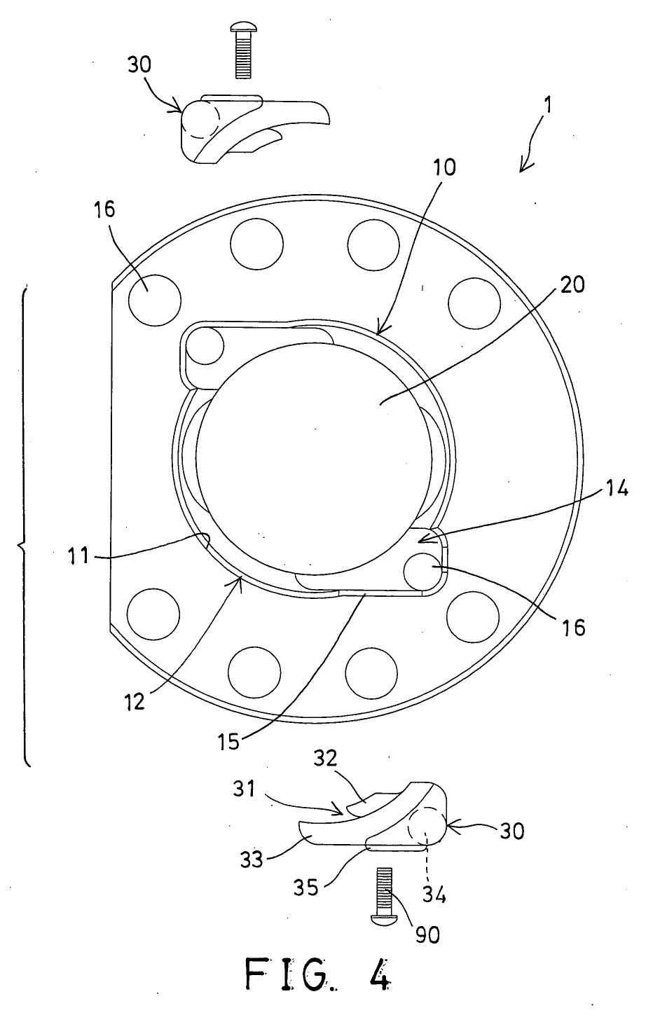

The ball nut 10 includes one or more, such as two depressions 14 formed therein (FIGS. 3-5), each for partially receiving a guide member 30, such as a ball guide member 30 therein (FIGS. 4-7), and includes one or more cavities 15 formed therein and communicating with the depressions 14 thereof respectively, and includes one or more, such as two channels 16 formed therein (FIGS. 3-5) and communicating with or between the depressions 14 thereof respectively, for communicating two or more peripheral and helical groove portions 13 of the ball nut 10 with each other.

The ball guide members 30 each includes a slot 31 formed therein and defined between two bars 32, 33, for communicating with the peripheral and helical groove portions 13 of the ball nut 10, and for slidably receiving the rolling members 88 therein. The bars 32, 33 of the ball guide members 30 may be aligned with or formed into a portion of the inner thread 12 of the ball nut 10, or the bars 32, 33 and the slot 31 of the ball guide members 30 may be aligned with or conformed with the inner thread 12 of the ball nut 10, or may be formed as a portion of the inner thread 12 of the ball nut 10.

The ball guide members 30 each further includes a curved pathway 34 formed therein and communicating with the slot 31 thereof, and directed toward or aligned with the channels 16 of the ball nut 10, best shown in FIG. 3, to guide the balls or rollers or rolling members 88 to move from the peripheral and helical groove portions 13, 22 of the ball nut 10 and the screw shaft.20 to and through the channels 16 of the ball nut 10, or to guide the rolling members 88 to move from the channels 16 of the ball nut 10 back to the peripheral and helical groove portions 13, 22 of the ball nut 10 and the screw shaft 20.

The alignment or conformity of the slots 31 of the ball guide members 30 and the peripheral and helical groove portions 13 of the ball nut 10 allows an endless ball rolling passage 80 to be formed by the slots 31 and the curved pathways 34 of the ball guide members 30 and the peripheral and helical groove portions 13, 22 of the ball nut 10 and the screw shaft 20, and for allowing or for guiding the balls or rollers or rolling members 88 to move along or around the endless ball rolling passage 80 of the ball screw device 1, and thus to allow the ball nut 10 to be smoothly rotated and moved relative to the screw shaft 20.

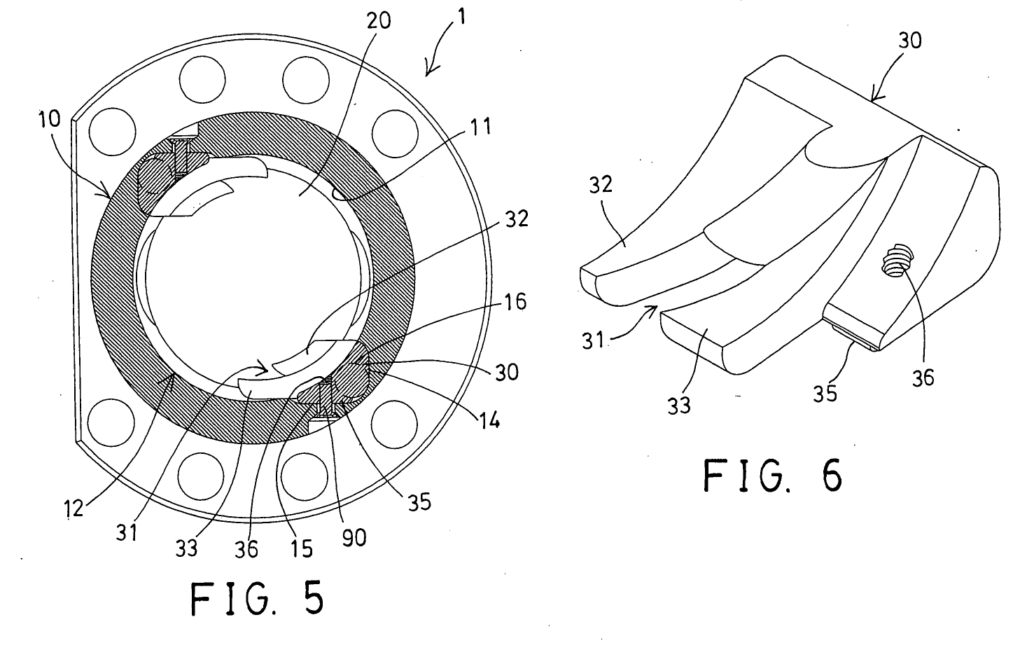

The ball guide members 30 each further includes a projection 35 extended therefrom for engaging into the depressions 14 of the ball nut 10, to anchor and to position the ball guide members 30 to the ball nut 10, and to prevent the ball guide members 30 from being moved relative to the ball nut 10. One or more fasteners 90 may further be provided (FIG. 4) and engaged through the ball nut 10, and secured to the ball guide members 30 with such as a screw hole or a threading engagement 36 (FIG. 5), to solidly secure the ball guide members 30 to the ball nut 10.

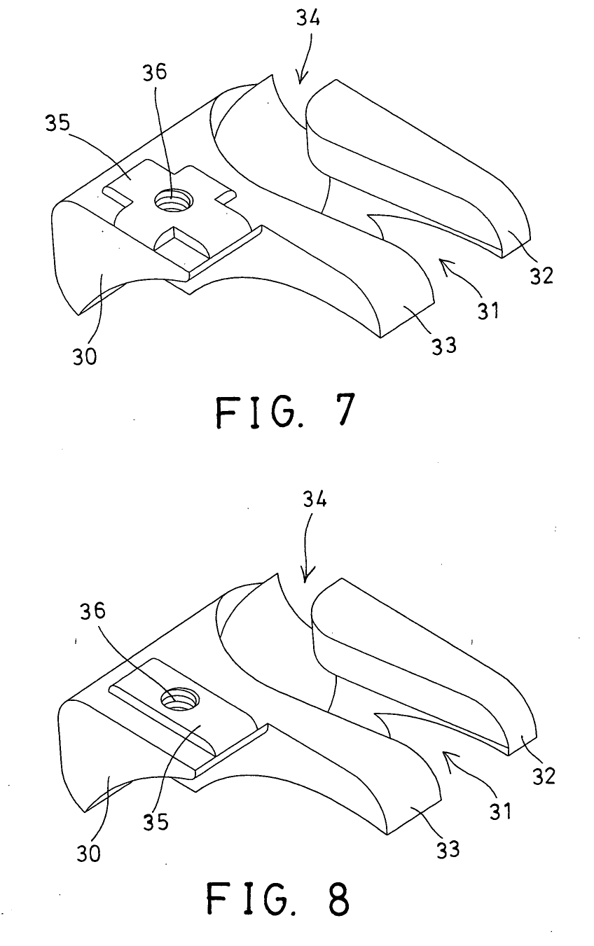

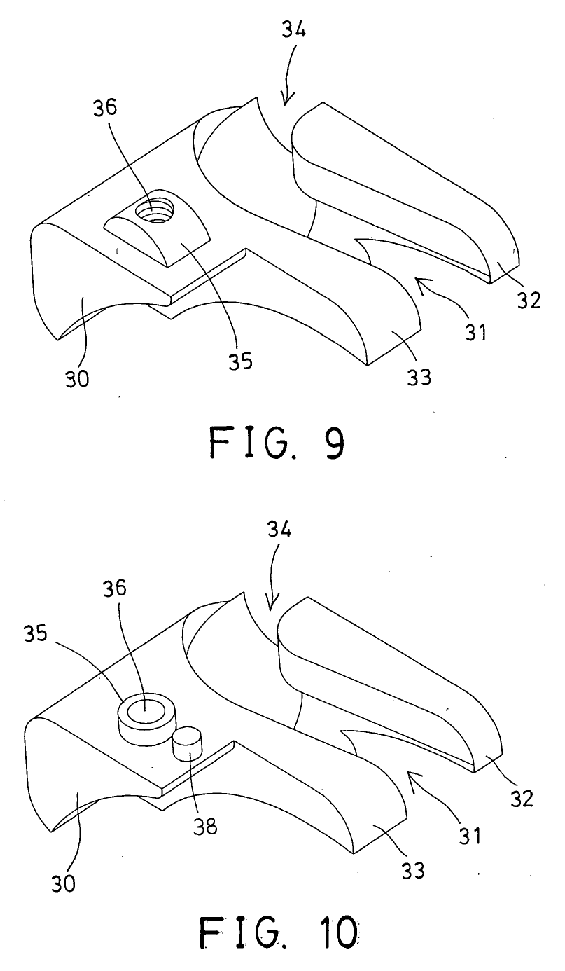

As shown in FIG. 7, the projection 35 of the ball guide members 30 and the corresponding depressions 14 or the cavities 15 of the ball nut 10 may be formed into various kinds of shapes, such as a cross-shape as shown in FIG. 7, a substantially rectangular or parallelepiped shape as shown in FIG. 8, a curved shape as shown in FIG. 9, or a circular or cylindrical shape as shown in FIG. 10. However, when the projection 35 includes a circular or cylindrical shape, a peg 38 is required to be provided and extended from the ball guide members 30 to engage with and to anchor to the ball nut 10.

When assembling the ball screw device 1, as shown in FIGS. 4 and 5, the ball guide members 30 may first be engaged into the corresponding depressions 14 of the ball nut 10 and to engage the projections 35 of the ball guide members 30 into the cavities 15 of the ball nut 10, and then to thread or to engage the fasteners 90 with the ball guide members 30, such as the screw hole or threading engagement 36 of the ball guide members 30, to solidly secure the ball guide members 30 to the ball nut 10, and to form the endless ball rolling passage 80 with the slots 31 and the curved pathways 34 of the ball guide members 30 and the peripheral and helical groove portions 13, 22 of the ball nut 10 and the screw shaft 20. Normally, two or more, or at least two ball guide members 30 are required to couple the peripheral and helical groove portions 13, 22 of the ball nut 10 and the screw shaft 20 together and to form the endless ball rolling passage 80.

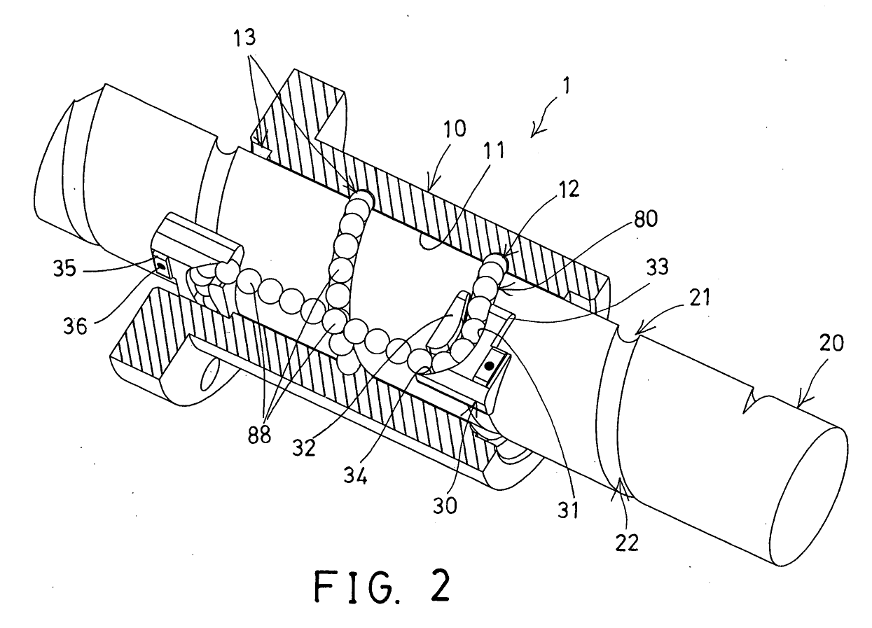

In operation, as shown in FIGS. 2, 3 and 5, when the ball nut 10 is rotated or moved relative to the screw shaft 20, or on the contrary when the screw shaft 20 is rotated or moved relative to the ball nut 10, particularly when the ball nut 10 and the screw shaft 20 are rotated or moved relative to each other in great rotational speeds, the rolling members 88 may facilitate the rotating movement of the ball nut 10 relative to the screw shaft 20 or between the ball nut 10 and the screw shaft 20.

Accordingly, the ball screw device in accordance with the present invention includes a ball guide member for effectively and smoothly receiving and guiding the balls or the rolling members to move relative to the ball nut and the screw shaft, and for facilitating the ball nut and the screw shaft to be rotated or moved relative to each other in great rotational speeds.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A ball screw device comprising:
a ball nut including a bore formed therein and having an inner thread formed therein and defined by a plurality of helical groove portions, and including at least one channel formed therein,
a screw shaft rotatably engaged into said bore of said ball nut, and including an outer thread formed thereon and defined by a plurality of helical groove portions for threading with said inner thread of said ball nut and for allowing said ball nut to be rotated and moved relative to said screw shaft,
a plurality of rolling members engaged in said helical groove portions of said ball nut and said screw shaft for facilitating a movement of said ball nut relative to said screw shaft, and
at least two guide members engaged in said ball nut and each including a slot formed therein for communicating said helical groove portions and said at least one channel of said ball nut with each other, and for forming an endless ball rolling passage to slidably receive said rolling members therein, and for guiding said ball nut and said screw shaft to rotate and to move relative to each other.

2. The ball screw device as claimed in claim 1, wherein said ball nut includes at least two depressions formed therein for receiving said at least two guide members respectively.

3. The ball screw device as claimed in claim 2, wherein said ball nut includes a cavity formed therein and communicating with each of said at least two depressions thereof, and said at least two guide members each includes a projection extended therefrom for engaging into said at least two depressions of said ball nut, to anchor and to position said guide members to said ball nut, and to prevent said guide members from being moved relative to said ball nut.

4. The ball screw device as claimed in claim 3, wherein said projection of said at least two guide members includes a cross shape.

5. The ball screw device as claimed in claim 1, wherein said ball nut includes at least two fasteners engaged therethrough and engaged with said at least two guide members respectively, to solidly secure said at least two guide members to said ball nut.

6. The ball screw device as claimed in claim 1, wherein said at least two guide members each includes a curved pathway formed therein and communicating with said slot thereof and directed toward and aligned with said at least one channel of said ball nut, to guide said rolling members to move to and from said helical groove portions of said ball nut and said screw shaft and said at least one channel of said ball nut.
